(19) United States
(12) Patent Application Publication
(10) Pub. No.: US 2018/0177161 A1
(43) Pub. Date: Jun. 28, 2018

(54) Closed Tank for Fish Farming and Method for Transporting Fish Into and Out From Such Tank

(71) Applicant: Arne Konsulent & Salg AS, Forsand (NO)

(72) Inventor: Arne Berge, Forsand (NO)

(21) Appl. No.: 15/738,425

(22) PCT Filed: Jul. 4, 2016
(86) PCT No.: PCT/NO2016/050151

§ 371 Date: Dec. 20, 2017

(30) Foreign Application Priority Data
Jul. 7, 2015 (NO) 20150884

(51) Int. Cl. A01K 61/13; A01K 61/60; A01K 79/00; A01K 63/02; A01K 63/04

(52) U.S. Cl. CPC A01K 61/13; A01K 61/60; A01K 63/06; A01K 63/02; A01K 63/047; A01K 79/00

(57) ABSTRACT

Closed tank for fish farming, in which the tank is equipped with a liquid tight housing and a water supply system, a water discharge system and at least a particle discharge means, the water supply system comprising a plurality of vertical inlet pipes which serve as a load-bearing element of the tank. The inlet pipes and a vertical pipe and interconnected pipes may constitute a load-bearing skeleton. The tank may have separate buoyance chambers dimensioned to provide sufficient buoyance even if one chamber should fail, and one chamber in contact with the water in the tank arranged to be filled with and drained of air, to thereby reduce and increase the water level in the tank.

### BACKGROUND

The disclosure concerns a closed tank for fish farming, and additionally concerns a method for transporting fish as indicated.

U.S. Pat. No. 4,798,168 describes a fish farming cage with a bag shaped enclosure. The fish cage has liquid tight bottom and wall sections. It may also comprise a roof or cover like e.g. a plastic cloth, tightly connected to the fish cage. Water supply and discharge of e.g. particles are included in the system. This system is clearly an improvement over open fish cages, but still has flaws when it comes to safety, comfort and control options.

U.S. Pat. No. 5,762,024 (1998) describes a fish farming tank with liquid tight bottom and walls. It may also comprise a tight roof, such as one made of glass fibres.

Norwegian patent No. 331 196 B1 teaches a fish cage in a mainly rigid material which isolates the water in the cage from the water outside. The cage is equipped with a supply of water and a discharge system. It is mainly semi-spherically shaped but can also comprise a roof making it spherical.

Norwegian patent application 88 2829A describes a bag-shaped fish cage comprising a soft fabric. Walls, bottom and roof are liquid tight. A predetermined air pressure may be maintained in the cage.

Norwegian patent No. 315 633 concerns a closed device for farming of marine organisms such as fish, with a longitudinally extending tank arranged to float partially immersed in the sea. At both ends there are openings for supply or discharge of water.

U.S. Pat. No. 8,424,491 describes a mainly spherical fish cage produced from a plurality of triangular elements.

Norwegian patent No. 332 585 teaches a method for discharge of fish from a closed fish cage where the fish is displaced down to the lower part of the cage and pumped out by means of a pump device.

As illustrated by the prior art above a number of improvement have been suggested to the existing fish net cages, a.o. to hold the fish better separated from the environment to prevent salmon lice from being spread to the environment and to reduce the risk of fish escaping from the cages.

There is, however, no solution providing path-breaking improvement to the operation of such farming systems and which both brings better comfort and safety for personnel operating these systems and at the same time ensures the well-being in a general manner, from the time at which it is brought into the system and to the time at which it leaves the system, including the transportation into and out from the cage or tank.

### SUMMARY OF THE INVENTION

The disclosure provides a tank for fish farming which is as efficient and compact as possible and which allows optimal control of operational parameters.

Also provided is a tank as mentioned above which reduces the risk for exposure to salmon lice to a minimum.

Another embodiment provides a tank for fish farming which provides a better, more controllable and more stable environment for the fish. The disclosed embodiments also are useful for leniently and efficiently bringing fish into and out from conventional fish cages for treatment.

The disclosed embodiments may also be used for transportation of fish from smolt plants to firs farming plants and from fish farming plants to slaughter plants.

The disclosed embodiments are safe and comfortable to operate under all operating conditions, requiring a minimum of maintenance and cleaning.

The disclosed tank is self-supported in the sense that the required pipes for supply and discharge of water also constitute the load-bearing structure of the tank.

Additionally, the tank is tight and regulation of the amount of air in the tank determines the vertical position of the tank in the sea and that a change in the vertical position can be used for pump free transportation of fish into and out from the tank.

Additionally, the tank is sun proof to prevent sunlight and excessive light. Too much light leads to growing of algae in the tank and on filter screens which would lead to reduced water flow and excessive needs for cleaning. The tank being sun proof also allows productions control by controlling the light throughout the day to determine day length for the fish. This in turn is significant in relation to pubescence and profitability.

The tank's normal condition is 90% submerged into water. During ordinary operation of water being pumped into the tank, the water level outside the tank will be somewhat higher than the water level inside the tank. The water level will reach somewhat up the walls in the buoyancy chambers. The difference will vary with the rate of water being pumped in and the difference in the salinity (density difference) of the water inside the tank compared to the water outside the tank. This difference pushes used water into the discharge pipe and out below the tank.

The tank is typically designed to fit into standard frame moorings used for traditional open fish cages.

The tank has doors positioned a short distance above water level for access by boat. Like with traditional fish cages, one can access the tank directly from boat. Either into technical rooms which also function as buoyancy chambers or into room open down to the water and the fish. In the rooms where the fish can be viewed, samples of the fish may be taken and operational tasks and controlling tasks as required in fish farming can be performed in usual manner. In technical rooms, dead fish, remains of fodder and dirt particles can be handled. Other technical rooms have pump controlling el-boards, emergency power aggregates or emergency oxygen tank. Tanks for storing fodder can also be integrated in the center of the tank within technical rooms. This replaces most of what traditionally have been arranged on fodder rafts in conventional fish farming cages. The commonly performed tasks can thus be performed indoors.

The tank design for collecting fodder waste and fish dirt means that little organic waste is spilled to the surrounding environment. This solution may therefore be used on many available farming locations which today no longer can be used for open fish cages which release organic waste. There is a large and increasing demand for new locations and the disclosed embodiments can contribute to resolve that.

The presence of a plurality of buoyance chambers increases safety. During unmanned operation the doors into the buoyancy chambers must be closed to ensure that the buoyancy effect is not jeopardized and the chambers filled with water caused by rain or waves.

When letting fish into or out from the tank, the tank will move upwards or downwards in accordance with its filling level. The water level within the tank will be approximately the same as the sea level outside; it is just the tank that moves during emptying and filling. The tank is designed with a height lower than its width for preventing it from turning over when floating in an empty condition.

When fish is transported into or out from the tank the doors to the room over the fish must be closed. In addition the vertical pipes should be closed at their top ends during the operation. This for allowing formation of an overpressure or an underpressure. When blowing in air the water level in the tank is reduced and the tank is elevated. Fish is transported through a dedicated transportation hose from the tank bottom and follows the water flow out to another tank or fish cage. Oppositely, transportation of fish into the tank can be performed by pumping air out.

Thereby an underpressure is created in the tank which allows water and fish to flow into the tank. During this operation the lower ends of the vertical pipes must partly be closed. A person skilled in the art will know that this is important and useful in order to treat salmon that is kept in traditional fish farming cages. Salmon in open fish cages tend to have lice or other parasites and must be treated in bathing solutions to eliminate such lice and/or parasites. The present tank with its lenient system for transportation of fish in and out will constitute an important tool for such treatment.

A particularly lenient treatment method made possible by the disclosed embodiments is to supply fresh water to the tank to treat against lice and parasites. It should also be possible to recycle the water while the treatment continues over some time. The solution involves an integrated air system for removal of C02 from the discharge water to be reused. This solution is placed inside the discharge conduit and subsequent aeration of C02 the water is directed through the uppermost horizontal pipes, to the supply pipes and down and to the fish. In the position at the connection with the lowermost horizontal pipes, only used water is sucked away at the discharge. This water circulates in ordinary manner in to the fish but with oxygen added. In this manner the fish can be treated the required time before it is returned to the fish cage. The pump suspension can preferably be so designed that during elevation from normal position it becomes closed preventing further water to be sucked in from outside. The pump can furthermore function as a valve.

Closed design with recycling of water can also be used during transportation of fish. It is a requirement that such transportation shall be closed to prevent dissemination of infection. Fish can be collected at a smolt plant and be towed to location for farming and further growth. Before slaughtering the tank can be towed to the location of a slaughter plant. The tank can be used for transporting own fish but also for replacing fish carriers for transportation to and from conventional open fish cages.

A person skilled in the art will know that lice larvae will be floating in the uppermost layers of water before being attached to fish. Arranging the pump inlet under the tank bottom thus will reduce the risk of lice larvae being brought in with the water.

The temperature in the sea varies over the year with the highest temperature occurring at the sea surface during summer, while the situation is opposite during wither. The temperature also controls the growth rate of the fish. By extending the hose at the pump inlet, the depth of the water intake can be adjusted to correspondingly adjust the temperature.

When positioning the tank on land for maintenance the tank will rest on the pipe ends. The tank can furthermore be used for farming on shore. Then the lower ends of the pipes must be connected to central supply and discharge pipes and/or to a dedicated water treatment plant. The construction then also needs reinforcement compared to embodiments made for use in the sea and/or partly be buried in the ground.

### BRIEF DESCRIPTION OF THE DRAWINGS

Below the tank is described in further detail in the form of exemplifying embodiments with reference to the enclosed drawings.

FIG. 1 shows schematically a simplified side section of an embodiment of a tank according to the disclosure.

FIG. 2 shows the tank of FIG. 1 in a side sectional view.

FIGS. 3a-3d show schematically simplified sections of different embodiments of the disclosed tank.

FIG. 4 shows schematically and simplified a side section of an embodiment of a tank.

FIG. 5 shows schematically and simplified a top section through an embodiment of the disclosed tank.

### DETAILED DESCRIPTION

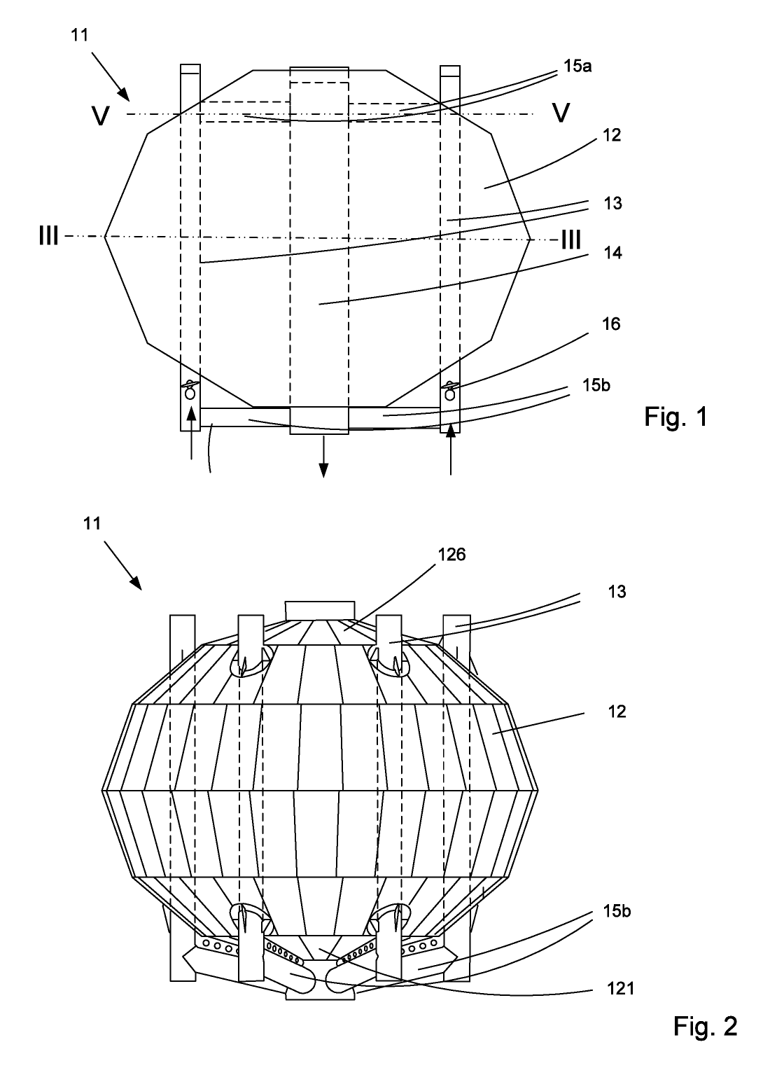

FIG. 1 shows a tank 11 according to the disclosure with an outer housing 12, vertical load-bearing elements 13 which also constitute inlet pipes for water, a vertical pipe 14 which at least comprises or consists of a discharge pipe but which also can include additional elements such as cables for power and communication etc. and which also constitutes a load bearing element of the tank, and interconnecting pipes 15a, 15b which connect the inlet pipes 13 and the pipe 14 both with regard to fluid flows but also as elements of the load-bearing construction.

The vertical inlet pipes are arranged evenly distributed along an imaginary circle line from the tank center. In practice ⅓ to ¼ of the radius' distance from the wall will be an optimal position in order to obtain good water circulation, i.e. the distance between the center pipe and the outer wall. This position ensures an optimal distribution of the water for obtaining good water circulation so that oxygen is well distributed throughout the tank volume. Then also the fish can be distributed and utilize the entire tank volume. A (any) horizontal section of the tank can have the shape of a circle or a polygon; most preferred the horizontal section is circularly.

The upper connecting pipes 15a are shown positioned inside the tank while the lower connecting pipes are shown outside, vertically below the housing 12 of the tank. The connecting pipes are preferably horizontal or substantially horizontal when the tank is in its normal operative position.

FIG. 1 furthermore shows a pump 16 with a valve function which can be used for opening and closing for supply of water, that being fresh water or saline water, preferably one in each inlet pipe 13. When closed and not pumping in supply water, the water already in the tank is held in circulation. Alternatively, not shown, additional oxygen is added to the water to maintain desired level of oxygen in the water.

FIG. 2 shows a side section of principally same tank as shown in FIG. 1 illustrating that the outer housing of the tank is assembled from plates of adapted dimensions. Each individual plate must be adapted with angles different from right-angled. This is simply obtained with modern design and construction tools. The shape typically is such that there is a desired inclination towards the middle center to direct all particles to a particle trap near the discharge.

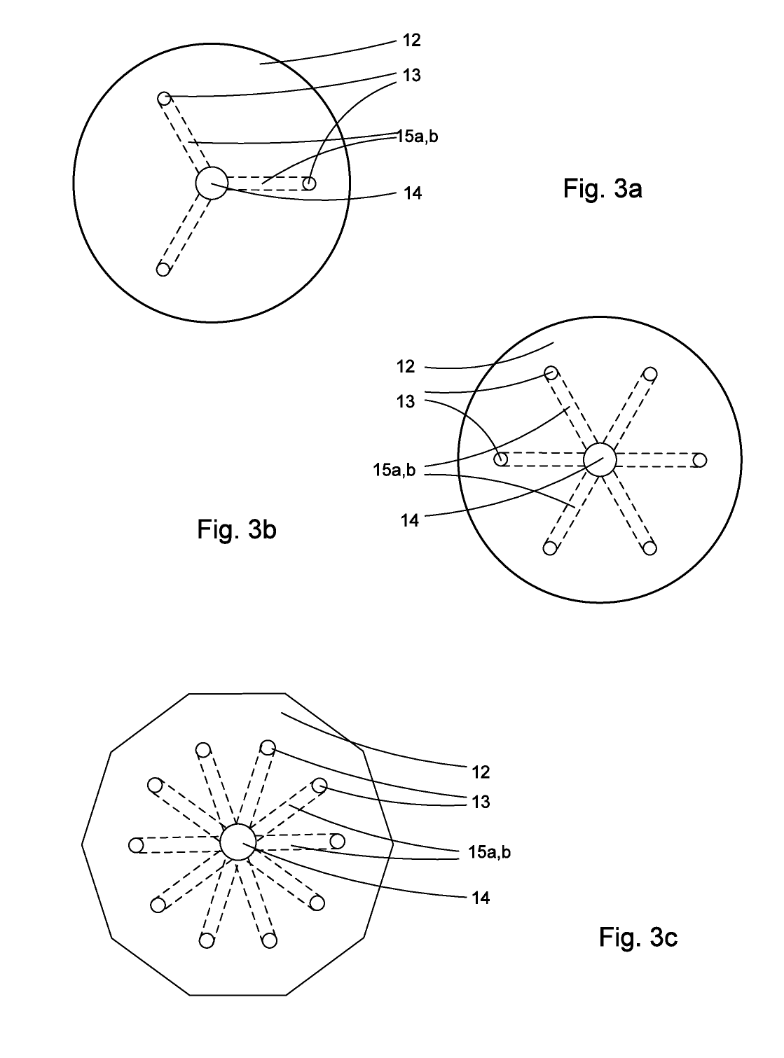

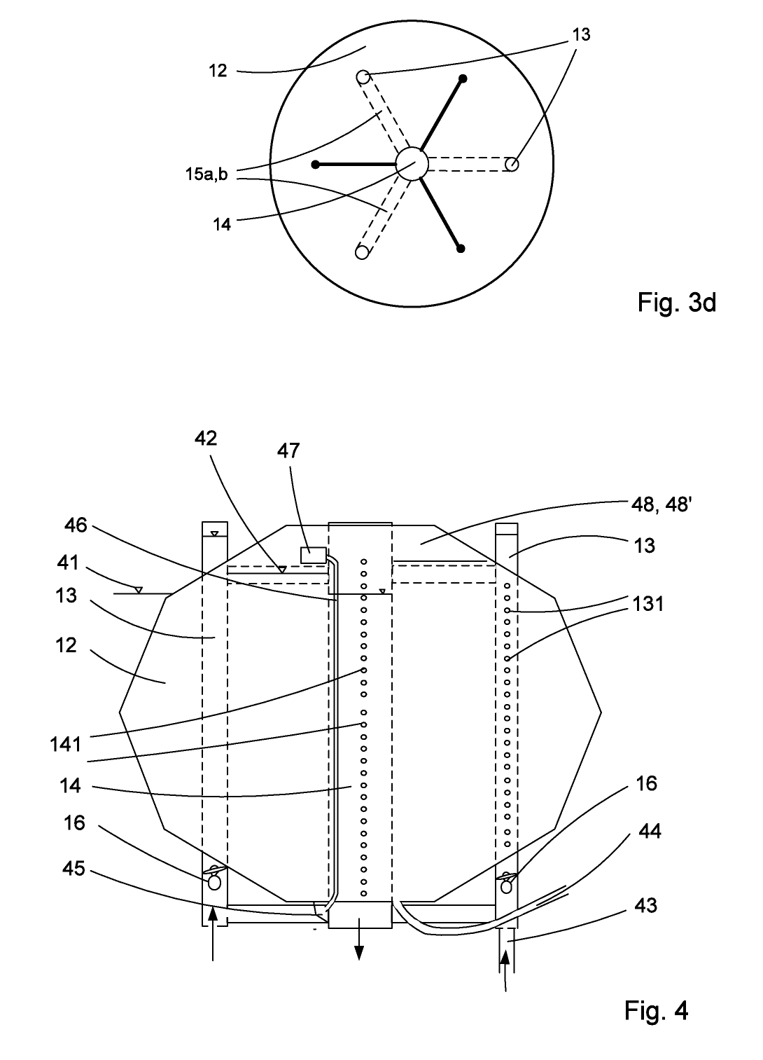

The FIGS. 3a-3d show schematically simplified horizontal sections of different embodiments of the tank according to the disclosure, the sections being positioned where the tank diameter is the largest, in a cross-sectional area illustrated by the dotted line marked III-III in FIG. 1. The number of pipes increases with increasing size of the tank in order to maintain strength and provide required support to the wall surfaces. Rather than simply increase the diameter of the pipes, their number is also increased.

FIG. 3a shows an embodiment only exhibiting three vertical inlet pipes, mutually displaced by 120 degrees along an imaginary circle line with center in the vertical pole 14 constituting or comprising a discharge pipe for water. The connecting pipes 15a and 15b are not in the section where the diameter is the largest and therefore indicated by dotted lines.

FIG. 3b shows principally the same as FIG. 3a but in an embodiment comprising six vertical pipes, mutually displaced by 60 degrees along an imaginary circle line. This embodiment corresponds to the one of FIGS. 1 and 2.

FIG. 3c shows still another embodiment, in this case a tank comprising a total of ten vertical inlet pipes. The person skilled in the art will understand that it is easier to obtain physical strength and stability with a higher number of loaf-bearing elements in the form of vertical pipes. The number of vertical pipes in the tank will most typically be in the range 3 to 12 depending on size.

FIG. 3c furthermore shows a tank having a horizontal section of the form of a polygon (decagon) rather than circularly. This is independent of the number of pipes in the tank and a tank with a decagon cross-section can also be used for embodiments having 8, 6, 5, 4 or 3 vertical pipes 13.

FIG. 3d shows a variant which similarly to the embodiment of FIG. 3a has three vertical inlet pipes but which, in addition to these, between each one of these, has separate vertical load-bearing elements which are also attached to the central vertical pipe constituting or comprising the discharge pipe. It is an alternative which may be desirable in certain connections, rather than increasing the number of inlet pipes, to add vertical and horizontal load-bearing elements which do not have any other function.

The vertical inlet pipes 13 are generally accessible from above, so that pumps, valves and other equipment can be lowered down from and retrieved from the tank top. The same goes for the vertical discharge pipe. Here one may for instance lower and retrieve equipment for aeration of the water.

FIG. 4 shows generally the same as FIG. 1 but showing additional details which in FIG. 1 are omitted to only show the main features.

FIG. 4 thus shows the same vertical inlet pipes 13, the same vertical pipe 14 and the same connecting pipes 15a, 15b as FIG. 1.

FIG. 4 furthermore shows external water level 41, internal water level 42, extension pipe or hose 43 for inlet water, fish transportation hose 44, particle and dead-fish trap 45, pipe 46 for transportation of dead fish and particles to the tank top, screen box or container 47 at the tank top and a closed volume of air 48 for buoyancy of the tank. Some rooms 48′ will lack floor and be open down to the water of the tank as explained in further detail below.

The tank is generally regarded tight and the upper part of the tank is air tight/gas tight to thereby allow pumping in air which to desired degree can expel water from the tank to thereby determine the tank's vertical position in the surrounding water. Furthermore this makes possible emptying of fish from the tank via a fish transportation hose 44 without the use of pumps, by gradually raising the tank by increasing the amount of air which automatically reduces the amount of water in the tank. Naturally compressors or blowers of significant volumetric capacity are required (but with modest pressure capacity) to fill such a tank within a reasonable time period.

In addition FIG. 4 shows openings 131 on one and the same side of one of the inlet pipes 13, suitable for adding new water and at the same time setting the water in the tank in rotation. More of the inlet pipes 13 can exhibit these type of openings distributed over a significant part of the height of the tank 11. The distribution of the holes high up, far down, or at the middle is done to optimize and ensure a good and even rotation. Normally the sum of the hole areas is equal to the cross-sectional area of the inlet pipe. Optimal flow rate for salmon increases with size, normally one fish length per second.

Also along the discharge pipe openings 141 are shown distributed over vertical levels of the tank. For the discharge pipe it is most important with openings at the lower end of the pipe.

Normally the sum of the hole areas is equal to the discharge pipe cross-sectional area. Optimally there are a number of holes at the lower end and to open more holes higher up during increased water rate. Discharging water higher up can inhibit the vortex at the tank center.

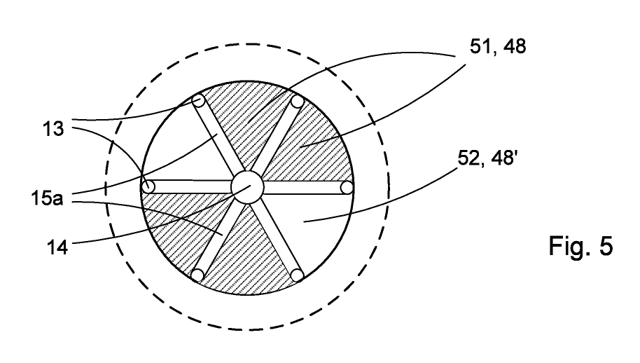

FIG. 5 shows a horizontal section of a tank generally similar to the tank shown in FIGS. 1, 2 and 3b, the section being positioned at a vertical level corresponding to the connecting pipes 15a, as illustrated by the broken line V-V in FIG. 1.

This level is a level at which it is required with personnel access for surveillance and maintenance performance. Therefore a floor 51 is established in part of the surface between or immediately above the connecting pipes 15a, while other parts 52 of the surface is open for allowing visual inspection of what is below. The level above the horizontal pipes shown in FIG. 5 will typically be divided into as many separate rooms as there are pipes. This means that there are tight walls from each pipe and up to the tank top. The rooms having floors (four in FIG. 5) function as separate buoyancy chambers (marked 48 in FIG. 4) and should there be a problem with one of them, still a sufficient number of buoyancy chambers will be intact. These chambers also function as technical rooms and will contain all technical equipment needed on board. In the chambers where there is no floor, visual inspection of the fish is possible. In addition these chambers serve to adjust the vertical position of the tank, by pumping in further amounts of air thereby allowing water and fish to flow out from the tank. Access to these rooms takes place through doors in the tank wall; doors that can be “hermetically” closed so as not to allow air to leak out in the situations where it is desired to reduce the water level in the tank by pumping in further amounts of air.

It is preferred that i) the vertical inlet pipes 13, ii) the vertical central pole 14 comprising a discharge pipe and iii) the connecting pipes 15a, b constitute a load-bearing skeleton of the tank 11.

It is furthermore preferred that the connecting pipes (15a, b) are mainly horizontal but some or all of them can also be inclined. Tit is not a requirement that the connecting pipes are arranged only at two distinct vertical levels but it is convenient in order not to disturb the flow conditions in the tank that the lowermost connecting pipes are arranged outside the tank.

It is also of importance that the chambers 48 with their walls and floors constitute separate buoyance chambers which hold the tank buoyant even if one of them should fail.

It is an additional feature that level adjustment, but also transportation of fish into and out from the tank, can take place by means of a level adjustment performed by increasing and reducing respectively the amount of air in chambers having direct contact with the water.

It is a particular feature of the disclosed embodiments that in connection with the chamber 48′ without floor (where the fish can be visually inspected) at least one channel from a compressor or blower is arranged to allow the blowing in of air to thereby control the amount of air in the chamber and the level of the tank in the seam and also allowing transportation of fish into and out from the tank by free flowing of water out of and into the tank respectively. For this purpose all doors and sluices in the upper part of the tank preferably are performed as air tight sluices.

It is furthermore preferred that a floor 51 is arranged near the upper connecting pipes (15a), covering a limited part of the horizontal cross-section of the tank.

At least one of the vertical inlet pipes (13) is preferably provided with nozzles (131) with a defined common circumferential orientation allowing inflowing water to set the mass of water in the tank into a rotating circulation about the central vertical pipe (14) through the tank. More typically more than one of the inlet pipes (13) are provided with such nozzles (131) all of the nozzles having a common circumferential orientation.

The tank 11 is preferably sun proof to prevent growth and algae. A person skilled in the art knows that excessive light leads to a lot of maintenance to eliminate such growth on walls and screens. The tank is illuminated artificially to give the ability of fully controlling the light as desired to obtain optimal biological effect on the fish.

The vertical inlet pipes 13 extend typically down below the housing 12 and can be extended to suck in water from other depths.

Using the disclosed tank the fish is held separately from the surrounding environment at the surface, where the there is a potential risk for infection of fish diseases and salmon lice, toxic algae and contaminations. It is thus possible to avid one of the largest problems related to fish farming today, the salmon lice, and as a consequence avoid expensive and risk bearing delousing processes. In addition dissemination of salmon lice to surrounding waters and rivers are prevented. In a closed tank (1) one will also have a very good overview over and control with the illness situation if illness should still break out. At an occurrence of illness one will be able to treat the fish with very precise dosages compared to treatment in open fish cages. Finally the risk for fish escape is close to being eliminated.

A detailed example of the method related to transportation of fish into and out from the tank can be describes as follows:

The discharge pipe 14 and the inlet pipes 13 are closed at their top so that air only can enter the tank through a compressor or blower and cannot escape from the tank.

The fish transportation hose 44 is opened and its outlet opening positioned at the location at which the fish is to be transported.

Water for circulation can be pumped in a regular manner or with changed rate as desired. Air is pumped into the tank's chamber 48′ so that the air expels water out from the tank. Inlet pipes and discharge pipe are held closed or closed with screens so that fish only can escape through the fish transportation hose.

Fish flows out through the fish transportation hose 44 along with water being expelled by the inflowing air to the chamber 48′.

When transporting fish into the tank the procedure above is reversed as air is pumped out from the chamber 48′ and water and fish flows into the tank through the fish transportation hose.

Most characteristic of the advantages when comparing with the best of prior art technology are probably the load-bearing structure of the tank, its safety against sinking by using a plurality of separate buoyancy chambers (48) which also serve the purpose as room for technical equipment as well as its ability of level adjustment combined with pump free transportation of fish into and out from the tank.

1-13. (canceled)

14. A closet tank (11) for fish farming where the tank, comprising:
a liquid tight housing (12) with a water supply system, a water discharge system and at least one particle discharge means, wherein
the water supply system comprises a plurality of mainly vertical inlet pipes (13) which constitute a load bearing element of the tank (11).

15. The tank of claim 14, wherein the vertical inlet pipes (13) have connecting pipes (15a, b) from a central, vertical pole (14) through the tank, the vertical pole (14) further comprising a water discharge pipe from the tank (11).

16. The tank of claim 14, wherein the vertical inlet pipes (13) have connecting pipes (15a, b) from a central, vertical pole (14) through the tank, the vertical pole (14) further defining a water discharge pipe from the tank (11).

17. The tank of claim 15, wherein the vertical inlet pipes (13), the vertical central pole (14) comprising a water discharge pipe, and the connecting pipes (15a, b) together constitute a load-bearing skeleton of the tank (11).

18. The tank of claim 16, wherein the vertical inlet pipes (13), the vertical central pole (14) comprising a water discharge pipe, and the connecting pipes (15a, b) together constitute a load-bearing skeleton of the tank (11).

19. The tank of claim 15, wherein the connecting pipes (15a, b) are mainly horizontal.

20. The tank of claim 16, wherein the connecting pipes (15a, b) are mainly horizontal.

21. The tank of claim 14, wherein an upper part of the tank comprises at least one closed, airtight chamber (48) functioning as a buoyancy chamber.

22. The tank of claim 14, wherein a floor (51) is arranged in proximity of the upper connecting pipes (15a), said floor covering a delimiting portion of a horizontal cross-section of the tank.

23. The tank of claim 15, wherein a floor (51) is arranged in proximity of the upper connecting pipes (15a), said floor covering a delimiting portion of a horizontal cross-section of the tank.

24. The tank of claim 14, comprising airtight chambers (48′) that allow blowing in an overpressure, thereby providing a pump-free transportation of fish from and to the tank.

25. The tank of claim 15, comprising airtight chambers (48′) that allow blowing in an overpressure, thereby providing a pump-free transportation of fish from and to the tank.

26. The tank of claim 15, wherein at least one of the vertical inlet pipes (13) is provided with nozzles (131) with a common circumferential orientation, allowing inflowing water to set the water body in the tank into a rotating circulation around the central, vertical pipe (14) through the tank.

27. The tank of claim 14, wherein the tank is sun proof and only illuminated artificially to allow full control of variation in illumination.

28. The tank (11) of claim 14, comprising a recess or receptacle in a bottom for collecting particles and dead fish and a device for transporting dead fish and particles to a top of the tank to a dewatering unit (47).

29. The tank (11) of claim 15, comprising a recess or receptacle in a bottom for collecting particles and dead fish and a device for transporting dead fish and particles to a top of the tank to a dewatering unit (47).

30. A closed tank (11) for fish farming, comprising a liquid tight housing (12) with a water supply system, a water discharge system and at least one particle discharge unit, wherein the tank has a top that is provided with separate buoyancy chambers (48) dimensioned to provide sufficient buoyance to the tank even if one of said buoyancy chambers fails, and one chamber (48′) in contact with water in the tank, arranged for being filled with and drained for air respectively, for corresponding reduction and increase of the water level in the tank.

31. The tank of claim 30, wherein filling of additional air into a chamber (48′) without a floor causes a reduction of the water level in the tank and optionally a transportation of fish out from the tank.

32. A method for transporting fish into and out from a closed tank (11), comprising:
blowing air from an inner chamber (48′) in contact with water in the tank (11) to cause an increase in a water level by inflowing of water from a fish transportation hose (44) connected to a reservoir containing fish, and
blowing air into at least one inner chamber (48′) in contact with water in the tank (11) causing an expulsion of water through a fish transportation hose (44) connected to a water reservoir outside the tank.
